(19) United States
(12) Patent Application Publication
(10) Pub. No.: US 2007/0035475 A1
(43) Pub. Date: Feb. 15, 2007

(54) Method of driving plasma display panel and plasma display apparatus driven using the method

(76) Inventors: Dong-Young Lee, Suwon-si (KR); Won-Ju Yi, Suwon-si (KR); Ho-Young Ahn, Suwon-si (KR); Kyoung-Doo Kang, Suwon-si (KR); Soo-Ho Park, Suwon-si (KR); Seok-Gyun Woo, Suwon-si (KR); Jae-Ik Kwon, Suwon-si (KR)

Correspondence Address: Robert E. Bushnell, Suite 300, 1522 K Street, N.W., Washington, DC, 20005, US

(21) Appl. No.: 11/478,651

(22) Filed: Jul. 3, 2006

(30) Foreign Application Priority Data
Aug. 10, 2005 (KR) 10-2005-0073325

(51) Int. Cl. G09G 3/28

(52) U.S. Cl. 345/63

(57) ABSTRACT

In a method and apparatus for improving the address discharge efficiency of a plasma display panel (PDP), the PDP has a new structure which improves light-emitting efficiency and reduces a permanent afterimage. The PDP includes first and second substrates spaced apart from each other, a barrier rib which, together with the first and second substrates partitions discharge cells which are discharge spaces, first and second electrodes extending so as to cross each other in the barrier rib, a phosphor layer formed in the discharge cells, and a discharge gas in the discharge cells. In the method and apparatus, each unit frame used to express an image is divided into a plurality of sub-fields, and each of the sub-fields is divided into a reset period wherein all discharge cells are initialized, an address period wherein a discharge cell which is turned on or off is selected from all discharge cells, and a sustain period wherein a sustain discharge is performed for a discharge cell selected to be turned on in the address period according to gray-level weights allocated to each of the sub-fields. In addition, a falling pulse is applied to the first electrode in the reset period, and scan pulses are sequentially applied to the first electrode in the address period. The electric potential of a low level of the scan pulse is lower than the electric potential of a minimum level of the falling pulse.

### CLAIM OF PRIORITY

This application makes reference to, incorporates the same herein, and claims all benefits accruing under 35 U.S.C. § 119 from an application for METHOD FOR DRIVING PLASMA DISPLAY PANEL earlier filed in the Korean Intellectual Property Office on 10 Aug. 2005 and there duly assigned Serial No. 10-2005-0073325.

### BACKGROUND OF THE INVENTION

1. Technical Field

The present invention relates to a plasma display panel (PDP) and, more particularly, to a method of driving a PDP having a new structure which improves light-emitting efficiency and reduces permanent afterimage, and to a plasma display apparatus driven using the method.

2. Related Art

Plasma display devices, which have generally conventional cathode ray tube (CRT) display devices, display a desired image using visible rays generated by sealing a discharge gas, applying discharge voltage between two panels of a PDP in which a plurality of electrodes are formed to generate vacuum ultraviolet radiation, and exciting a phosphor by the vacuum ultraviolet radiation in a predetermined pattern.

A plasma display panel (PDP) has a first panel and a second panel. The first panel includes a front substrate, a dielectric layer which covers scan electrode lines and sustain electrode lines at the rear of the first substrate, and a protection layer which protects the first dielectric layer. The scan electrode lines and sustain electrode lines are paired to form a pair of sustain electrodes, and include bus electrodes formed of metal, and transparency electrodes formed of a transparent and conductive material such as indium tin oxide (ITO) to increase a conductivity.

The second panel includes a second substrate, a second dielectric layer which is formed in a direction of the first substrate at the front of the second substrate so as to cover address electrode lines which cross the scan electrode lines and the sustain electrode lines, a plurality of address electrodes, barrier ribs which partition discharge cells in the top of the second dielectric layer, a phosphor layer formed in a space partitioned by the barrier ribs, and a second protection layer formed in the front of the phosphor layer for protecting the phosphor layer. A discharge gas is injected in the discharge cells, i.e., the space partitioned by the barrier ribs.

The 3D surface discharge type PDP displays an image by dividing a frame into a plurality of sub fields, and by classifying each of the sub fields as a reset period, an address period, and a sustain period. However, the 3D surface discharge type PDP has the following disadvantages:

First, visible rays emitted from the phosphor layer are considerably absorbed by the scan electrode lines and sustain electrode lines which are arranged beneath the first substrate, the first dielectric layer covering the scan electrode lines and sustain electrode lines, and the first protection layer, thereby reducing light-emitting efficiency.

Second, when the 3D surface discharge type PDP displays an image for a long time, the phosphor layer is ion-sputtered due to charge particles of the discharge gas, thereby causing a permanent afterimage.

### SUMMARY OF THE INVENTION

The present invention relates to a method of improving the address discharge efficiency of a plasma display panel (PDP) having a new structure which improves light-emitting efficiency and reduces permanent afterimage, and to a plasma display apparatus driven using the method.

According to an aspect of the present invention, there is provided a method of driving a plasma display panel (PDP) which includes first and second substrates spaced apart from each other, a barrier rib which, together with the first and second substrates, partitions discharge cells which are discharge spaces, first and second electrodes extending so as to cross each other in the barrier rib, a phosphor layer formed in the discharge cells, and a discharge gas in the discharge cells. Accordingly to the inventive method, each unit frame used to express an image is divided into a plurality of sub-fields, and each of the sub-fields is divided into a reset period when all discharge cells are initialized, an address period when a discharge cell which is turned on or off is selected from all discharge cells, and a sustain period when a sustain discharge is performed for a discharge cell selected to be turned on in the address period according to gray-level weights allocated to each of the sub-fields. A falling pulse is applied to the first electrode in the reset period, and scan pulses are sequentially applied to the first electrode in the address period. The electric potential of a low level of the scan pulse is lower than the electric potential of a minimum level of the falling pulse.

A sustain pulse having alternatively a high level and a low level is applied to the first electrode in the sustain period, a rising pulse may be applied to the first electrode in the reset period before the falling pulse is applied to the first electrode, and the rising pulse and the falling pulse may be ramp pulses.

A bias voltage is applied to the second electrode in the reset period while the falling pulse is applied to the first electrode, a display data signal is applied to the second electrode in the address period in accordance with the scan pulse, and an intermediate electric potential between the high level and the low level of the sustain pulse is applied to the second electrode in the sustain period.

According to another aspect of the present invention, there is provided a method of driving a PDP which includes first and second substrates spaced apart from each other, a barrier rib which, together with the first and second substrates, partitions discharge cells which are discharge spaces, first and second electrodes extending in a direction in the barrier rib, a third electrode extending so as to cross the first and second electrodes in the barrier rib, a phosphor layer formed in the discharge cells, and a discharge gas in the discharge cells. According to the inventive method, each unit frame used to express an image is divided into a plurality of sub-fields, and each of the sub-fields is divided into a reset period when all discharge cells are initialized, an address period when a discharge cell which is turned on or off is selected from all discharge cells, and a sustain period when a sustain discharge is performed for a discharge cell selected to be turned on in the address period according to gray-level weights allocated to each of the sub-fields. A falling pulse is applied to the first electrode in the reset period, and scan pulses are sequentially applied to the first electrode in the address period. The electric potential of a low level of the scan pulse is lower than the electric potential of a minimum level of the falling pulse.

Sustain pulses having alternately a high level and a low level are applied to the first electrode and the second electrode in the sustain period, a rising pulse is applied to the first electrode in the reset period before the falling pulse is applied to the first electrode, and the rising pulse and the falling pulse may be ramp pulses.

A bias voltage is applied to the second electrode between the reset period where the falling pulse is applied and the address period, and a display data signal is applied to the third electrode in the address period in accordance with the scan pulse.

According to an aspect of the present invention, there is provided a plasma display apparatus comprising: a PDP which includes first and second substrates spaced apart from each other, a barrier rib which, together with the first and second substrates, partitions discharge cells which are discharge spaces, first and second electrodes extending so as to cross each other in the barrier rib, a phosphor layer formed in the discharge cells, and a discharge gas in the discharge cells; and drivers for applying a driving signal, which is divided into reset, address, and sustain periods, to each of the first and second electrodes so as to drive the PDP. Each unit frame used to express an image is divided into a plurality of sub-fields, and each of the sub-fields is divided into the reset period when all discharge cells are initialized, the address period when a discharge cell which is turned on or off is selected from all discharge cells, and the sustain period when a sustain discharge is performed for a discharge cell selected to be turned on in the address period according to gray-level weights allocated to each of the sub-fields. The drivers are classified into a first driver which applies the driving signal to the first electrode, and a second driver which applies the driving signal to the second electrode. The first driver applies a falling pulse in the reset period and a scan pulse in the address period to the first electrode, and the electric potential of a low level of the scan pulse is lower than the electric potential of a minimum level of the falling pulse.

The first driver applies a sustain pulse having alternatively a high level and a low level to the first electrode in the sustain period. The first driver applies a rising pulse to the first electrode in the reset period before the first driver applies the falling pulse the first electrode, and the rising pulse and the falling pulse may be ramp pulses.

The second driver applies a bias voltage to the second electrode in the reset period while the first driver applies the falling pulse to the first electrode, applies a display data signal to the second electrode in the address period in accordance with the scan pulse, and applies an intermediate electric potential between the high level and the low level of the sustain pulse to the second electrode in the sustain period.

According to another aspect of the present invention, there is provided a plasma display apparatus comprising: a PDP which includes first and second substrates spaced apart from each other, a barrier rib which, together with the first and second substrates, partitions discharge cells which are discharge spaces, first and second electrodes extending in a direction in the barrier rib, a third electrode extending so as to cross the first and second electrodes in the barrier rib, a phosphor layer formed in the discharge cells, and a discharge gas in the discharge cells; and drivers for applying a driving signal, which is divided into reset, address, and sustain periods, to each of the first, second, and third electrodes so as to drive the PDP. Each unit frame used to express an image is divided into a plurality of sub-fields, and each of the sub-fields is divided into the reset period when all discharge cells are initialized, the address period when a discharge cell which is turned on or off is selected from all discharge cells, and the sustain period when a sustain discharge is performed for a discharge cell selected to be turned on in the address period according to gray-level weights allocated to each of the sub-fields. The drivers are divided into a first driver which applies the driving signal to the first electrode, a second driver which applies the driving signal to the second electrode, and a third driver which applies the driving signal to the third electrode. The first driver applies a falling pulse in the reset period and a scan pulse in the address period to the first electrode, and the electric potential of a low level of the scan pulse is lower than the electric potential of a minimum level of the falling pulse.

The first and second drivers apply a sustain pulse having alternatively a high level and a low level to the first and second electrodes in the sustain period, the first driver applies a rising pulse to the first electrode in the reset period before the first driver applies the falling pulse the first electrode, and the rising pulse and the falling pulse may be ramp pulses.

The second driver applies a bias voltage to the second electrode in the reset period, while the first driver applies the falling pulse to the first electrode, and the third driver applies a display data signal to the third electrode in the address period in accordance with the scan pulse.

### BRIEF DESCRIPTION OF THE DRAWINGS

A more complete appreciation of the invention and many of the attendant advantages thereof will be readily apparent as the same becomes better understood by reference to the following detailed description when considered in conjunction with the accompanying drawings in which like reference symbols indicate the same or similar components, wherein:

FIG. 1 is a partially exploded perspective view of a 3D surface discharge type plasma display panel (PDP);

FIG. 2 is a cross-sectional view of the PDP of FIG. 1 taken along line II-II in FIG. 1;

FIG. 3 is a perspective view of a PDP which has improved light-emitting efficiency and reduced permanent afterimage, and which uses a method of driving the PDP according to an embodiment of the present invention;

FIG. 4 is a cross-sectional view of the PDP of FIG. 3 taken along line IV-IV in FIG. 3;

FIG. 5 illustrates discharge cells and electrodes appearing in FIGS. 3 and 4;

FIG. 6 is a timing diagram for explaining a method of driving the PDP illustrated in FIG. 3;

FIG. 7 is a block diagram of the PDP illustrated in FIG. 3 and a plasma display apparatus for driving the PDP according to an embodiment of the present invention;

FIG. 8 illustrates waveforms of a driving signal for driving the PDP illustrated in FIG. 3 according to an embodiment of the present invention;

FIG. 9 is a perspective view of a PDP which has improved light-emitting efficiency and reduced permanent afterimage, and which uses a method of driving the PDP according to another embodiment of the present invention;

FIG. 10 is a cross-sectional view of the PDP of FIG. 9 taken along line X-X in FIG. 9;

FIG. 11 illustrates discharge cells and electrodes appearing in FIGS. 9 and 10;

FIG. 12 is a block diagram of the PDP illustrated in FIG. 9 and a plasma display apparatus for driving the PDP according to another embodiment of the present invention; and

FIG. 13 illustrates waveforms of a driving signal for driving the PDP illustrated in FIG. 9 according to another embodiment of the present invention.

### DETAILED DESCRIPTION OF THE INVENTION

The present invention will now be described more fully with reference to the accompanying drawings, in which exemplary embodiments of the invention are shown.

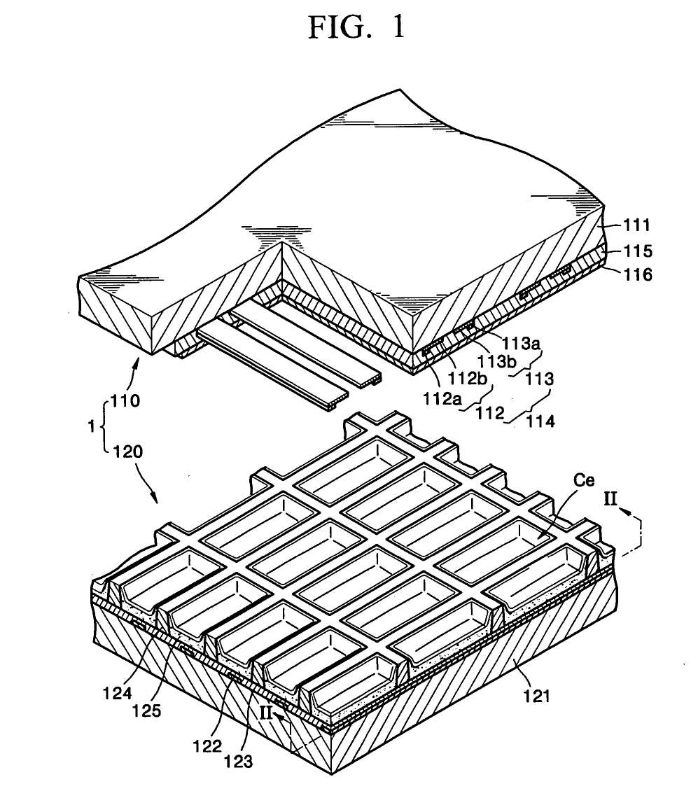

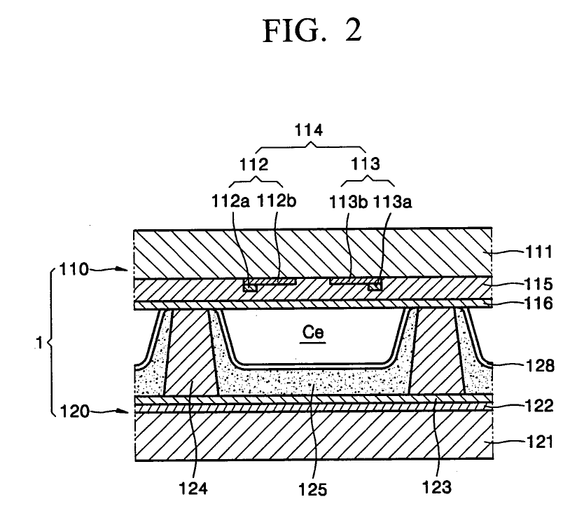

FIG. 1 is a partially exploded perspective view of a 3D surface discharge type PDP, and FIG. 2 is a cross-sectional view of the PDP of FIG. 1 taken along line II-II in FIG. 1.

Referring to FIGS. 1 and 2, the PDP 1 has a first panel 110 and a second panel 120. The first panel 110 includes a front substrate 111, a dielectric layer 115 which covers scan electrode lines 112 and sustain electrode lines 113 at the rear of the first substrate 111, and a protection layer 110 which protects the first dielectric layer 115. The scan electrode lines 112 and sustain electrode lines 113 are paired to form a pair of sustain electrodes 114, and include bus electrodes 112a and 113a formed of metal, and transparency electrodes 112b and 113b formed of a transparent and conductive material such as indium tin oxide (ITO) to increase conductivity.

The second panel 120 includes a second substrate 121, a second dielectric layer 123 which is formed in a direction of the first substrate 111 at the front of the second substrate 121 so as to cover address electrode lines 122 which cross the scan electrode lines 112 and the sustain electrode lines 113, a plurality of address electrodes 116, barrier ribs 124 which partition discharge cells Ce in the top of the second dielectric layer 123, a phosphor layer 125 formed in a space partitioned by the barrier ribs 124, and a second protection layer 128 formed in the front of the phosphor layer 125 for protecting the phosphor layer 125. A discharge gas is injected into the discharge cells Ce, i.e., the space partitioned by the barrier ribs 124.

The 3D surface discharge type PDP 1 illustrated in FIGS. 1 and 2 displays an image by dividing a frame into a plurality of sub fields, and classifying each of the sub fields as a reset period, an address period, and a sustain period. However, the 3D surface discharge type PDP 1 has the following disadvantages:

First, visible rays emitted from the phosphor layer 128 are considerably absorbed by the scan electrode lines 112 and sustain electrode lines 113 which are arranged beneath the first substrate 110, the first dielectric layer 115 covering the scan electrode lines 112 and sustain electrode lines 113, and the first protection layer 116, thereby reducing light-emitting efficiency.

Second, when the 3D surface discharge type PDP 1 displays an image for a long time, the phosphor layer 128 is ion-sputtered due to charge particles of the discharge gas, thereby causing a permanent afterimage;

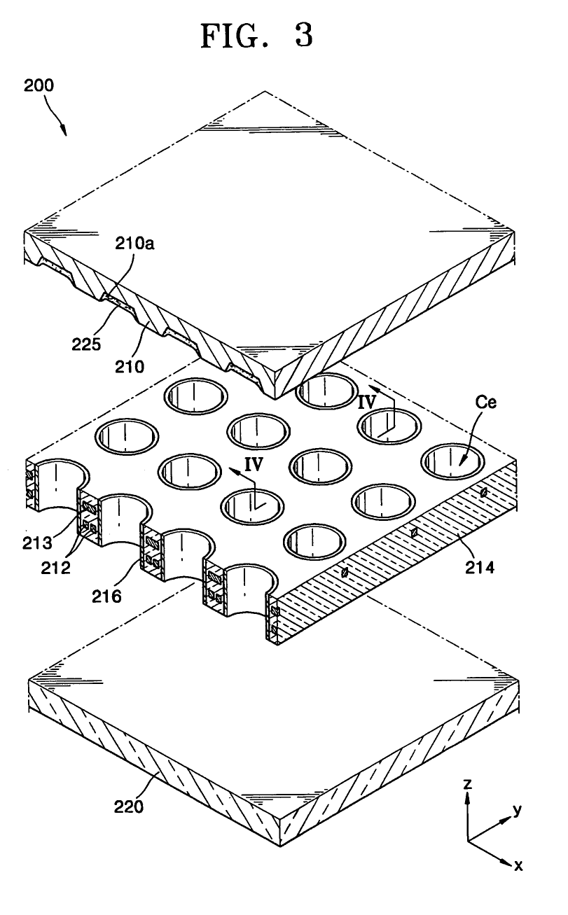

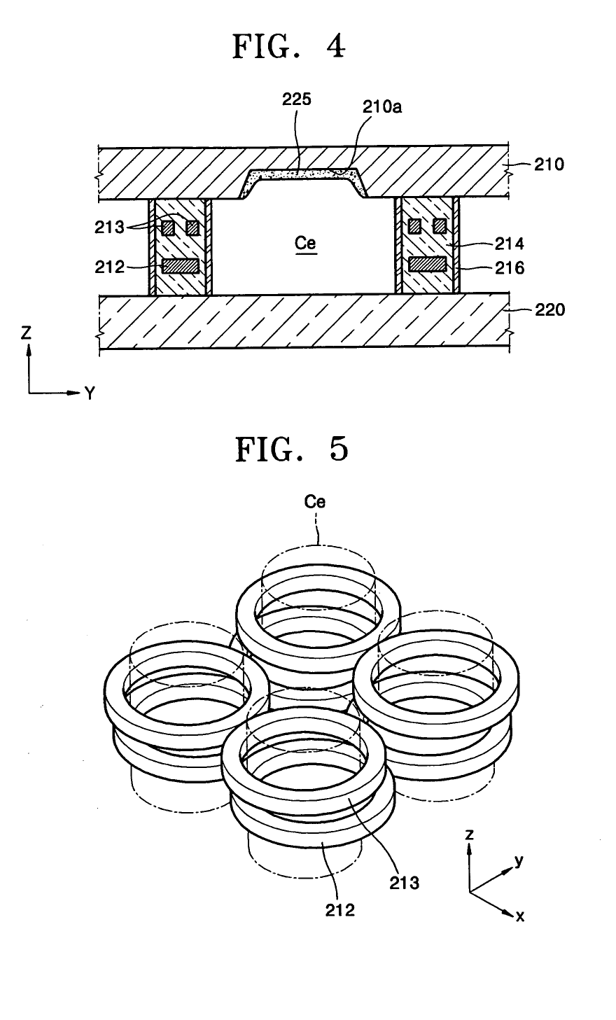

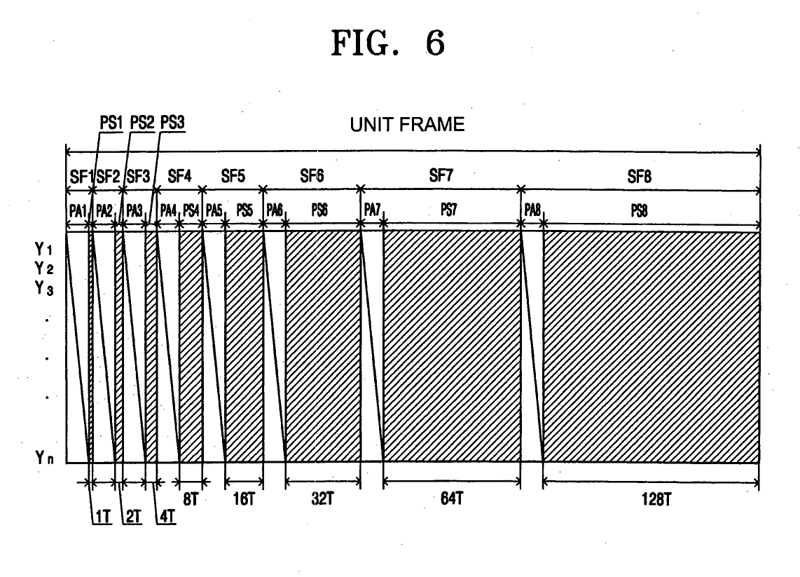

FIG. 3 is a perspective view of a plasma display panel (PDP) which has improved light-emitting efficiency and reduced permanent afterimage, and which uses a method of driving the PDP according to an embodiment of the present invention. FIG. 4 is a cross-sectional view of the PDP of FIG. 3 taken along line Iv-IV in FIG. 3. FIG. 5 illustrates discharge cells and electrodes appearing in FIGS. 3 and 4.

Referring to FIGS. 3 thru 5, the PDP 200 includes a first substrate 210, a second substrate 220, a barrier rib 214, a first electrode 212, a second electrode 213, a phosphor layer 225, a protection layer 216, and a discharge gas.

The first and second substrates 210 and 220, respectively, are spaced apart from each other. The barrier rib 214 may be formed in a single body as illustrated in the drawings, or may be divided into a front barrier rib and a rear barrier rib which are attached to the first and second substrates 210 and 220, respectively. The barrier rib 214, together with the first and second substrates 210 and 220, respectively, partitions the discharge cell Ce which is a space for performing a discharge. The discharge cells Ce, not necessarily restricted thereto, may be formed in an aperture having a circular cross-section in the barrier rib 214. The discharge cells Ce may have triangular, rectangular, pentagonal, or oval cross-sections. Also, the barrier rib 214, not necessarily restricted thereto, may partition the discharge cells Ce in the form of a matrix. If the barrier rib 214 forms a plurality of discharge spaces, the discharge cells Ce may be partitioned in a variety of patterns, such as a waffle pattern, a delta pattern, etc.

The first and second electrodes 212 and 213, respectively, are spaced apart from each other in the barrier rib 214. The first and second electrodes 212 and 213, respectively, not necessarily restricted thereto, may entirely surround the discharge cells Ce. The discharge cells Ce may be partly surrounded by the first and second electrodes 212 and 213, respectively. The first and second electrodes 212 and 213, respectively, extend in x and y directions, respectively. The second electrode 213 and the first electrode 212, not necessarily restricted thereto, are sequentially arranged in a direction (a z direction) from the first substrate 210 to the second substrate 220.

The first protection layer 216, formed of MgO, is preferably arranged in the exterior surface of the barrier rib 214 forming the discharge cells Ce. When a discharge is performed, the first protection layer 216 protects the first and second electrodes 212 and 213, respectively, and the barrier rib 214, formed of a dielectric substance which covers the first and second electrodes 212 and 213, respectively, discharges a secondary electron, facilitating the discharge.

The phosphor layer 225 is formed on the first substrate 210, and, more specifically, in a groove 210a formed on the first substrate 210 in a direction of the second substrate 220. The phosphor layer 225 may be formed in a groove (not shown) formed on the second substrate 220 in a direction of the first substrate 210, or may be formed on both of the first and second substrates 210 and 220, respectively.

The discharge gas, which is injected into the discharge cells Ce, is a mixture of xenon (Xe) under 10% or over 10%, and one or two others selected from neon (Ne), helium (He), and argon (Ar).

The first and second substrates 210 and 220, respectively, are formed of a transparent material such as glass. The second substrate 220 is spaced apart from the first substrate 210. The first and second substrates 210 and 220, respectively, are preferably formed of the same material. It is advantageous that the first and second substrates 210 and 220, respectively, have the same coefficient of thermal expansion.

When discharge is performed, the barrier rib 214 prevents the first and second electrodes 212 and 213, respectively, from electrically connecting to each other, and from being damaged due to collision with charge particles. The barrier rib 214 is formed of a dielectric substance that induces charge particles and accumulates wall charge. The dielectric substance may be PbO, B₂O₃, SiO₂, or the like.

A predetermined voltage is applied to each of the first and second electrodes 212 and 213, respectively, so as to perform the discharge. The first and second electrodes 212 and 213, respectively, are preferably formed of highly conductive Ag, Cu, Cr, or the like.

The phosphor layer 225 is formed by coating a phosphor paste, including a red light-emitting phosphor substance, a green light-emitting phosphor substance or a blue light-emitting phosphor substance, together with a solvent and a binder, on the groove 210a formed on the first substrate 210, drying the coated groove, and forming a metal. The red light-emitting phosphor substance is Y(V,P)O₄:Eu; the green light-emitting phosphor substance is Zn₂SiO₄:Mn, YBO₃:Tb; and the blue light-emitting phosphor substance is BAM:Eu.

A second protection layer (not shown) formed of MgO may be formed in the front (a-z direction) of the phosphor layer 225. When the discharge is performed in the discharge cells Ce, the second protection layer prevents the phosphor layer 225 from deteriorating due to collision with discharge particles, and discharges secondary electrons, making discharge easier.

The PDP 200 illustrated in FIGS. 3 thru 5 is advantageous relative to PDPs of the prior art.

First, since the PDP 200 does not require additional dielectric layers for the first and second electrodes 212 and 213, respectively, and forms the first and second electrodes 212 and 213, respectively, in the barrier rib 214, the visible rays generated by the discharge performed in the discharge cells Ce are directly emitted through the first substrate 210 and/or the second substrate 220, so that light-emitting efficiency is increased, and a transparent electrode such as ITO is not required.

Second, the first and second electrodes 212 and 213, respectively, are formed in the barrier rib 214 and around the discharge cells Ce so that an electric field focuses on the center of the discharge cells Ce. Although the PDP 200 displays an image for a long time, the phosphor layers 225 are not ion-sputtered due to charge particles of the discharge gas, thereby avoiding a permanent afterimage. Also, discharge is performed in every space of the discharge cells Ce, thereby increasing response speed and discharge efficiency.

FIG. 6 is a timing diagram for explaining a method of driving the PDP illustrated in FIG. 3. Referring to FIG. 6, each unit frame used to express an image is divided into 8 sub-fields SF1 thru SF8. Each of the sub-fields SF1 thru SF8 is divided into a reset period (not shown), an address period PA1 thru PA8, and a sustain period PS1 thru PS8, respectively. The reset period equally initializes all discharge cells, each of the address periods PA1 thru PA8 selects a discharge cell that is turned on or off from all discharge cells, and each of the sustain periods PS1 thru PS8 performs a sustain discharge for a discharge cell selected to be turned on in the address periods PA1 thru PA8 according to gray-level weights 1 T, 2 T, 4 T, 8 T, 16 T, 32 T, 64 T, and 128 T allocated to each of the sub-fields SF1 thru SF8. The PDP 200 is driven using a time-division driving method in which a driving signal is applied according to the reset period, the address periods PA1 thru PA8, and the sustain periods PS1 thru PS8 of each of the sub-fields SF1 thru SF8.

The sub-fields SF1 thru SF8, the reset period (not shown), the address periods PA1 thru PA8, the sustain discharge period PS1 thru PS8, and the gray-level weights 1 T, 2 T, 4 T, 8 T, 16 T, 32 T, 64 T, and 128 T are not necessarily restricted thereto. In detail, the number of the sub-fields of the unit frame maybe under or over 8, and the allocation of the gray-level weights to the sub-fields may be modified according to the type of design.

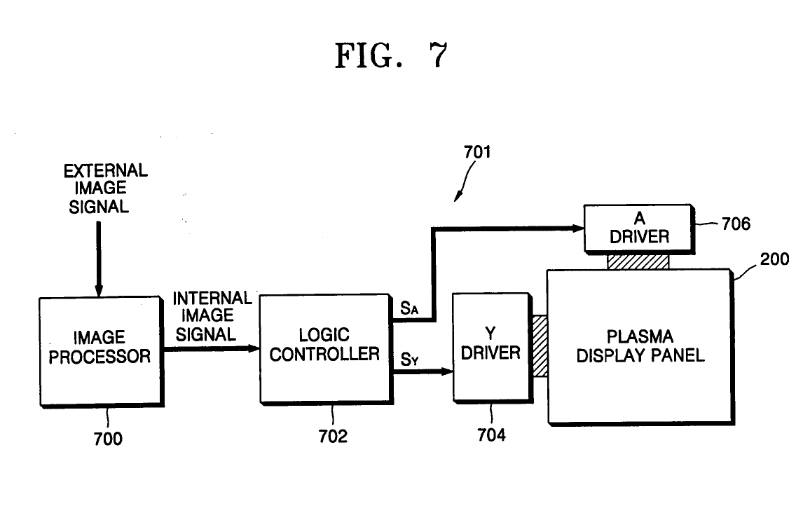

FIG. 7 is a block diagram of the PDP illustrated in FIG. 3 and a plasma display apparatus for driving the PDP according to an embodiment of the present invention. The PDP 200 includes two electrodes which are arranged in the barrier rib 214. Therefore, the plasma display apparatus 701 has a simpler structure than the PDP 1 of FIG. 1, which includes three electrodes.

Referring to FIGS. 3 thru 7, the plasma display apparatus 701 includes an image processor 700, a logic controller 702, a Y driver 704, an A driver 706, and the PDP 200.

The image processor 700 converts an external analog image signal, such as a PC signal, a DVD signal, a video signal, a TV signal or the like, into a digital signal, image-processes the converted digital signal, and outputs an internal image signal. The internal image signal includes 8-bit red (R), green (G) and blue (B) image data, a clock signal, and vertical and horizontal synchronization signals.

The logic controller 702 outputs a Y driving control signal SY and an A driving control signal SA by processing a gamma correction, an automatic power control (APC) for the internal image signal received from the image processor 700.

The Y driver 704 receives the Y driving control signal SY from the logic controller 702, and applies a driving signal to the first electrode 212 of FIGS. 3 thru 5. The A driver 706 receives the A driving control signal SA from the logic controller 702, and applies a driving signal to the second electrode 213 of FIGS. 3 thru 5. Hereinbelow the first electrode 212 and the second electrode 213 will now be referred to as a Y electrode and an A electrode, respectively.

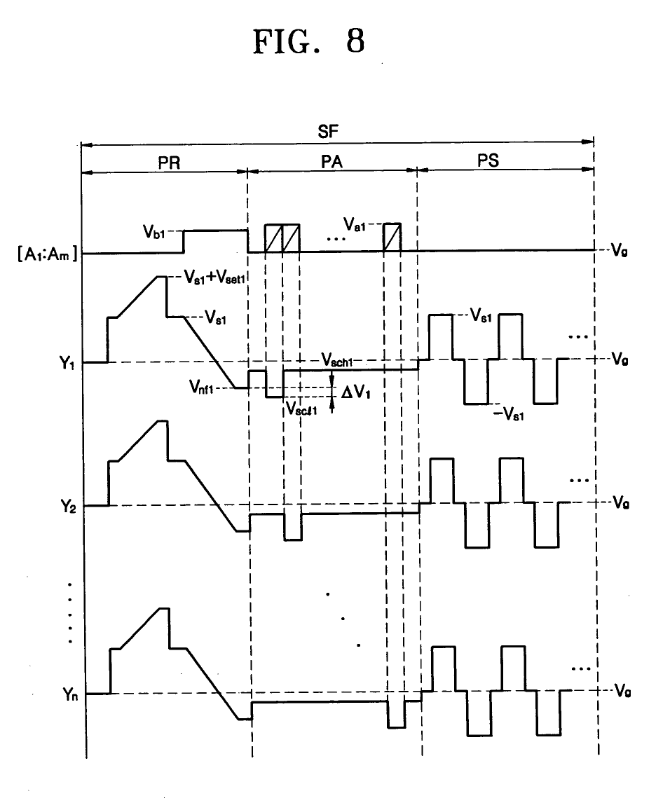

The Y driver 704 applies a falling pulse in the reset period, a scan pulse in the address periods PA1 thru PA8, and a sustain pulse in the sustain periods PS1 thru PS8 to the Y electrode 212. The electric potential of a low level of the scan pulse is lower than the electric potential of a minimum level of the falling pulse (the difference in the electric potential between the scan pulse and the falling pulse is ΔV1 as illustrated in FIG. 8). The difference in the electric potential between the Y electrode 212 and the A electrode 213 is longer than the reset period when an address discharge is performed in the address periods PA1 thru PA8, so that discharge efficiency is improved. Also, a lot of wall charge is accumulated around the Y electrode 212 after the address discharge is performed so that a sustain discharge is more efficiently performed in the sustain periods PS1 thru PS8. The Y driver 704 can also apply a rising pulse before applying the falling pulse to the Y electrode 212. The Y driver 704 can apply the rising pulse and the falling pulse in the form of a ramp pulse. If the Y driver 704 applies the ramp pulse, the Y driver 704 can linearly control wall charge accumulated in the discharge cells in the reset period, such that the reset discharge is not performed as a strong discharge but rather as a weak discharge.

The A driver 706 applies a display data signal to the address periods PA1 thru PA8 in accordance with the scan pulse. The address discharge is performed in the address periods PA1 thru PA8 using the display data signal and the scan pulse. The Y driver 704 applies the scan pulse to the Y electrode 212 so that the electric potential of the low level of the scan pulse is lower than the electric potential of the minimum level of the falling pulse, thereby controlling a high level electric potential of the display data signal. In detail, the high level electric potential of the display data signal can be reduced on the assumption that the address discharge is well performed.

FIG. 8 illustrates waveforms of a driving signal for driving the PDP illustrated in FIG. 3 according to an embodiment of the present invention. Referring to FIGS. 3 thru 8, each of the sub-fields SF is divided into a reset period PR, an address period PA, and a sustain period PS, respectively.

In the reset period PR, when all discharge cells are initialized, a rising ramp pulse and a falling ramp pulse are applied to the Y electrode 212, and a low level voltage, for example, a ground voltage Vg, is applied to the A electrode 213, whereas a bias voltage Vb1 is applied to the A electrode 213 when the falling ramp pulse is applied. The rising ramp pulse rises from a sustain discharge voltage Vs1 to a rising maximum voltage Vs1+Vset1, and the falling ramp pulse falls from the sustain discharge voltage Vs1 to a falling minimum voltage Vnf1. The application of the rising ramp pulse results in the accumulation of negative wall charge around the Y electrode 212 in all of the discharge cells, so that the reset discharge is performed between the Y electrode 212 and the A electrode 213. The application of the falling ramp pulse results II in the erasure of the negative wall charge accumulated around the Y electrode 212 in all of the discharge cells, so that the reset discharge is performed between the Y electrode 212 and the A electrode 213. The reset discharge initializes the state of the wall charge accumulated in all of the discharge cells so that the state of the wall charge can be suitable for the address discharge performed in the address period PA.

The address period PA is a period wherein a discharge cell which is turned on or off is selected from all of the discharge cells during the address discharge. Although a write discharge method is used to perform the address discharge in a discharge cell which is turned on in FIG. 8, it is not necessarily restricted thereto. That is, a selective erasure method may be used to perform the address discharge in all of the discharge cells, and an erasure method may be performed in a discharge cell that is turned off. In the write discharge method, a scan pulse having sequentially a high level electric potential Vsch1 and a low level electric potential Vscl1 is applied to the Y electrode 212, and the display data signal having a positive electric potential Va1 is applied to the A electrode 213 in accordance with the low level electric potential Vscl1 of the scan pulse. The application of the scan pulse and the display data signal results in performance of address discharge between the Y electrode 212 and the A electrode 213 of the discharge cells. After the address discharge is performed, positive wall charge is accumulated around the Y electrode 212, and negative wall charge is accumulated around the A electrode 213. In the current embodiment of the present invention, the low level electric potential Vscl1 of the scan pulse is lower than the falling minimum voltage Vnf1 of the falling ramp pulse. That is, the low level electric potential Vscl1 of the scan pulse is lower by a predetermined difference ΔV1 than the minimum electric potential Vnf1 of the falling ramp pulse. The difference in electric potential between the Y electrode 212 and the A electrode 213 is greater in address discharge than in reset discharge, so that the address discharge is more efficiently performed, and a large quantity of wall charge is accumulated around electrodes of the discharge cells after the address discharge is completely performed. Also, based on the assumption that the address discharge is well performed, the greater the predetermined difference ΔV1, the more the positive electric potential Val of the display data signal can be reduced, thereby reducing switching loss of the display data signal having a high switching frequency.

The sustain period PS is a period in which a sustain discharge is performed according to the gray-level weights allocated to the discharge cell which is turned on. A sustain pulse alternately having a high level Vs1 and a low level −Vs1 is applied to the Y electrode 212, and an intermediate electric potential Vg between the high level Vs1 and the low level -Vs1 of the sustain pulse is applied to the A electrode 213. A high level electric potential of the sustain pulse is referred to as a sustain discharge voltage Vs1. The number of sustain pulses is proportional to the gray-level weights. That is, a gray-level is changed in proportion to the gray-level weights allocated by the number of sustain discharges. If the sustain pulse of the high level Vs1 is applied to the Y electrode 212, the sustain discharge is performed by the positive wall charge accumulated around the Y electrode 212 of the discharge cells, the negative wall charge accumulated around the A electrode 213, the electric potential Vs1 applied to the Y electrode 212, and the electric potential Vg applied to the A electrode 213. After the sustain discharge is performed, the positive wall charge and the negative wall charge are accumulated around the A electrode 213 and the Y electrode 212, respectively. If the sustain pulse of the low level −Vs1 is applied to the Y electrode 212, the sustain discharge is performed by the negative wall charge accumulated around the Y electrode 212 of the discharge cells, the positive wall charge accumulated around the A electrode 213, the electric potential −Vs1 applied to the Y electrode 212, and the electric potential Vg applied to the A electrode 213. After the sustain discharge is performed, the negative wall charge and the positive wall charge are accumulated around the A electrode 213 and the Y electrode 212, respectively. Therefore, the sustain discharge is continuously performed according to the number of sustain pulses determined by the gray-level weights.

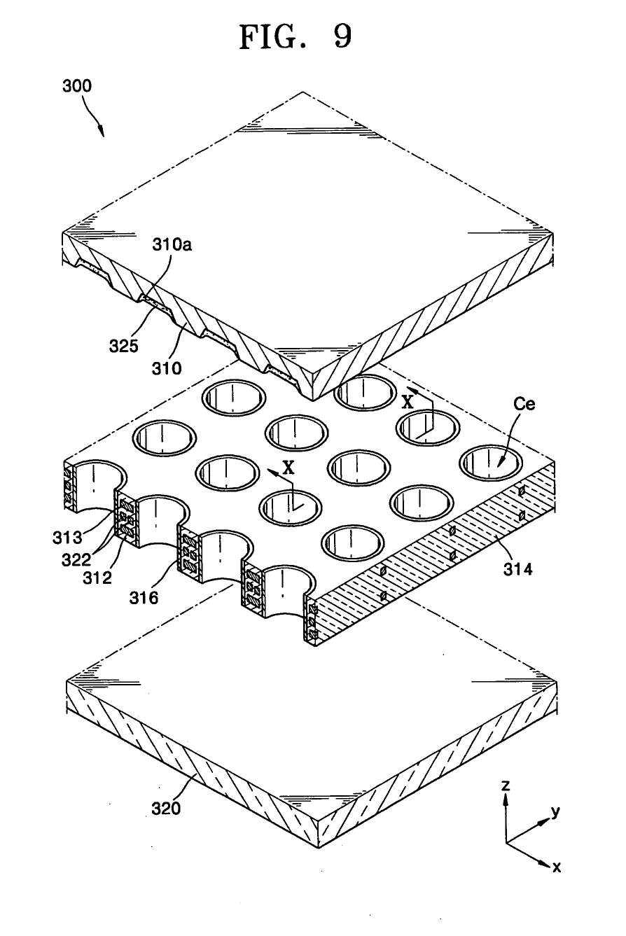

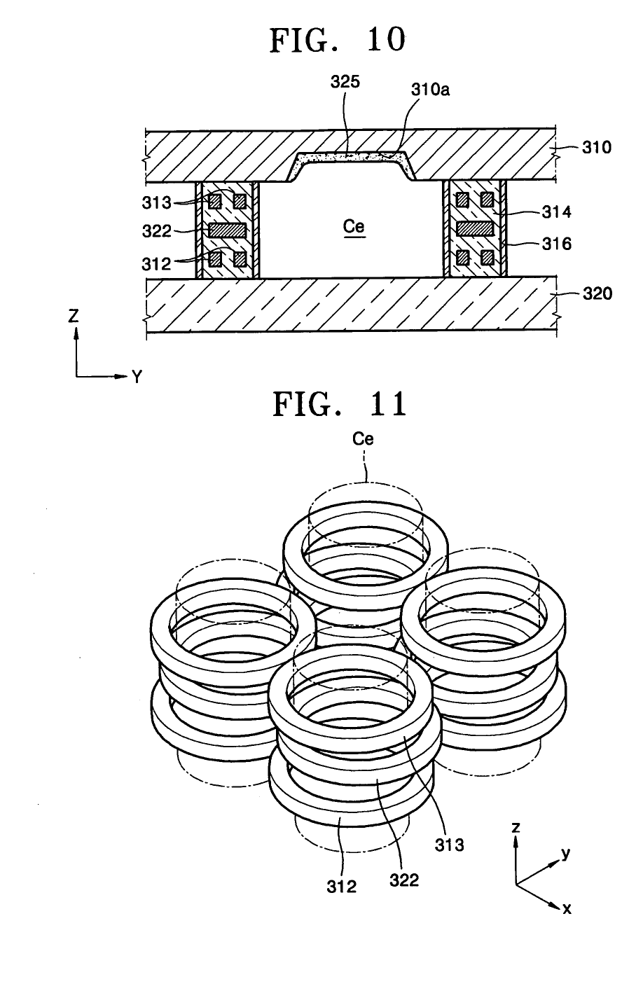

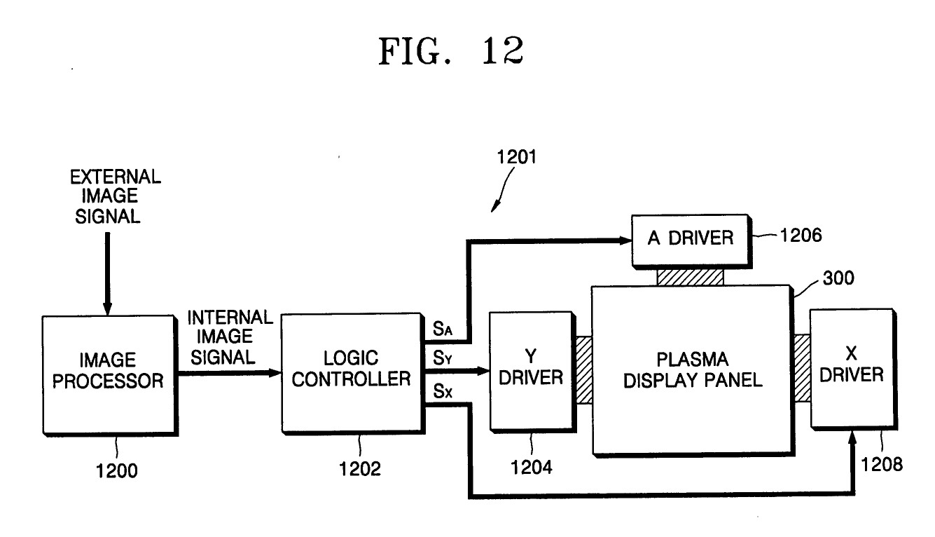

FIG. 9 is a perspective view of a PDP which has improved light-emitting efficiency and reduced permanent afterimage, and which uses a method of driving the PDP according to another embodiment of the present invention. FIG. 10 is a cross-sectional view of the PDP of FIG. 9 taken along line X-X in FIG. 9. FIG. 11 illustrates discharge cells and electrodes appearing in FIGS. 9 and 10.

The PDP 300 is similar to the PDP 200 illustrated in FIGS. 3 thru 5 except that the PDP 300 includes three electrodes, whereas the PDP 200 includes two electrodes. The difference between the PDP 300 and the PDP 200 will now be described.

Referring to FIGS. 9 thru 11, the PDP 300 includes a first substrate 310, a second substrate 320, a barrier rib 314, a first electrode 312, a second electrode 313, a third electrode 322, a phosphor layer 325, a first protection layer 316, and a discharge gas.

The description of the first substrate 310, the second substrate 320, the barrier rib 314, the phosphor layer 325, the first protection layer 316, and the discharge gas is the same as the description of corresponding elements of FIGS. 3 thru 5.

The first, second and third electrodes 312, 313, and 322, respectively, are spaced apart from one another in the barrier rib 314. The first, second and third electrodes 312, 313 and 322, respectively, not necessarily restricted thereto, may surround the entire discharge cells Ce. The discharge cells Ce may be partly surrounded by the first, second, and third electrodes 312, 313 and 322, respectively. The first and second electrodes 312 and 313, respectively, extend in a direction (the x direction), and the third electrode 322 extends in a direction (the y direction) so as to cross the first and second electrodes 312 and 313, respectively. The second electrode 313, the third electrode 322, and the first electrode 312, not necessarily restricted thereto, are sequentially arranged in a direction (the -z direction) from the first substrate 310 to the second substrate 320, and may be arranged according to various designs.

The PDP 300 illustrated in FIGS. 9 thru 11 have the same advantage as the PDP 200 illustrated in FIGS. 3 thru 5.

FIG. 12 is a block diagram of the PDP illustrated in FIG. 9 and a plasma display apparatus for driving the PDP according to another embodiment of the present invention. The plasma display apparatus 1201 illustrated in FIG. 12 is similar to the plasma display apparatus 701 of FIG. 7. The difference between both plasma display apparatuses will now be described.

Referring to FIGS. 9 thru 12, the plasma display apparatus 1201 includes an image processor 1200, a logic controller 1202, a Y driver 1204, an A driver 1206, an X driver 1208, and the PDP 300.

The image processor 1200 performs the same function as the image processor 700 of FIG. 7.

The logic controller 1202 outputs a Y driving control signal SY, an A driving control signal SA, and an X driving control signal SX by processing a gamma correction, an APC for an internal image signal received from the image processor 1200.

The Y driver 1204 receives the Y driving control signal SY from the logic controller 1202, and applies a driving signal to the first electrode 312 of FIGS. 9 thru 11. The X driver 1208 receives the X driving control signal SX from the logic controller 1202, and applies a driving signal to the second electrode 313 of FIG. 9 thru 11. The A driver 1206 receives the A driving control signal SA from the logic controller 1202, and applies a driving signal to the third electrode 322 of FIGS. 9 thru 11. Hereinbelow the first electrode 312, the second electrode 313, and the third electrode 322 will now be referred to as a Y electrode, an X electrode, and an A electrode, respectively.

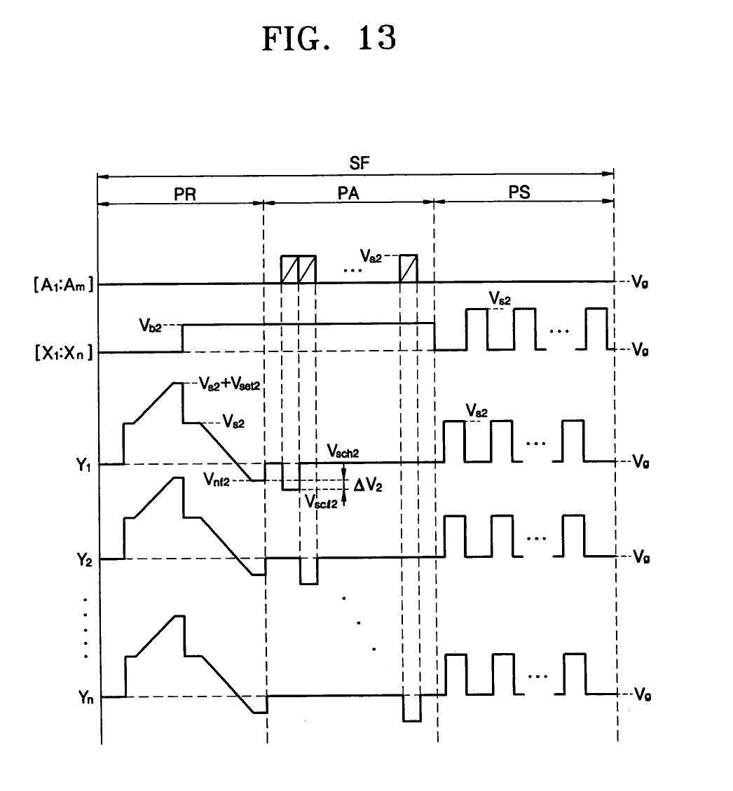

The Y driver 1204 applies, to the Y electrode 312, a falling pulse in the reset period, a scan pulse in the address period, and a sustain pulse in the sustain period. In this regard, a low level electric potential of the scan pulse is lower than a minimum level electric potential of the falling pulse (a difference of the electric potential between the scan pulse and the falling pulse is referred to as ΔV2 as illustrated in FIG. 13). The difference in the electric potential between the Y electrode 312 and the A electrode 322 is greater in the address discharge than in the reset discharge, so that the address discharge is more efficiently performed, and a large quantity of wall charge is accumulated around the Y electrode 312 after the address discharge is completely performed. The Y driver 1204 can also apply the rising pulse to the Y electrode 312 before applying the falling pulse to the Y electrode 312. The Y driver 1204 can apply the rising pulse and the falling pulse in the form of a ramp pulse. If the Y driver 1204 applies the ramp pulse to the Y electrode 312, the Y driver 1204 can linearly control wall charge accumulated in the discharge cells in the reset period, so that the reset discharge is not performed as a strong discharge but rather as a weak discharge.

The X driver 1208 applies the bias voltage Vb2 from the reset period in which the falling pulse is applied to the address period, and applies the sustain pulse in the sustain period. The sustain pulses outputted by the Y driver 1204 and the X driver 1208 alternate, thereby performing the sustain discharge in the discharge cells.

The A driver 1206 applies a display data signal to the address periods PA1 thru PA8 in accordance with the scan pulse. The address discharge is performed in the address periods PA1 thru PA8 using the display data signal and the scan pulse. The Y driver 1204 applies the scan pulse to the Y electrode so that the electric potential of the low level of the scan pulse is lower than the electric potential of the minimum level of the falling pulse, thereby controlling a high level electric potential of the display data signal. In detail, the high level electric potential of the display data signal can be reduced based on the assumption that the address discharge is well performed.

FIG. 13 illustrates waveforms of a driving signal for driving the PDP illustrated in FIG. 9 according to another embodiment of the present invention. The method described in FIG. 9 uses a time division gray level expression as illustrated in FIG. 6. The driving signal of FIG. 13 is similar to the driving signal of FIG. 8. The difference between the two driving signals will now be described.

Referring to FIGS. 9 thru 13, each of the sub-fields SF is divided into a reset period PR, an address period PA, and a sustain period PS, respectively.

In the reset period PR when all discharge cells are initialized, a rising ramp pulse and a falling ramp pulse are applied to the Y electrode 312, a low level voltage (for example, a ground voltage Vg) is applied to the A electrode 322, a bias voltage Vb2 is applied to the X electrode 313 when the falling ramp pulse is applied, and the ground voltage Vg is applied to the A electrode 322. The rising ramp pulse rises from a sustain discharge voltage Vs2 to a rising maximum voltage Vs2+Vset2, and the falling ramp pulse falls from the sustain discharge voltage Vs2 to a falling minimum voltage Vnf2. The application of the rising ramp pulse results in the accumulation of negative wall charge around the Y electrode 312 in all of the discharge cells, so that the reset discharge is performed between the Y electrode 312 and the A electrode 322, and between the Y electrode 312 and the X electrode 313. The application of the falling ramp pulse results in the erasure of the negative wall charge accumulated around the Y electrode 312 in all of the discharge cells, so that the reset discharge is performed between the Y electrode 312 and the A electrode 322, and between the Y electrode 312 and the X electrode 313. The reset discharge initializes the state of the wall charge accumulated in all of the discharge cells so that the state of the wall charge can be suitable for the address discharge performed in the address period PA.

The address period PA is a period in which a discharge cell which is turned on or off is selected from all of the discharge cells during the address discharge. Although a write discharge method is used to perform the address discharge in a discharge cell that is turned on in FIG. 13, it is not necessarily restricted thereto. That is, a selective erasure method may be used to perform the address discharge in all of the discharge cells, and an erasure method may be performed in a discharge cell which is turned off. In the write discharge method, a scan pulse having sequentially a high level electric potential Vsch2 and a low level electric potential Vscl2 is applied to the Y electrode 312, the display data signal having a positive electric potential Va2 is applied to the A electrode 322 in accordance with the low level electric potential Vscl2 of the scan pulse, and the bias voltage Vb2 is continuously applied to the X electrode 313. The application of the scan pulse and the display data signal results in performance of the address discharge between the Y electrode 312 and the A electrode 322 of the discharge cells. After the address discharge is performed, positive wall charge is accumulated around the Y electrode 312, and negative wall charge is accumulated around the A electrode 322. In the current embodiment of the present invention, the low level electric potential Vscl2 of the scan pulse is lower than the falling minimum voltage Vnf2 of the falling ramp pulse. That is, the low level electric potential Vscl1 of the scan pulse is lower by a predetermined difference ΔV2 than the minimum electric potential Vnf2 of the falling ramp pulse. A difference in the electric potential between the Y electrode 312 and the A electrode 322 is greater in the address discharge than in the reset discharge, so that the address discharge is more efficiently performed, and a large quantity of wall charge is accumulated around electrodes of the discharge cells after the address discharge is completely performed. Also, based on the assumption that the address discharge is well performed, the greater the predetermined difference ΔV2, the more positive electric potential Va2 of the display data signal can be reduced, thereby reducing switching loss of the display data signal having a high switching frequency.

The sustain period PS is a period in which a sustain discharge is performed according to the gray-level weights allocated to the discharge cell which is turned on. A sustain pulse having alternately the high level Vs2 and a low level Vg is applied to the Y electrode 312 and the X electrode 313, and the low level electric potential Vg of the sustain pulse is applied to the A electrode 322. A high level electric potential of the sustain pulse is referred to as a sustain discharge voltage Vs2. The number of sustain pulses is proportional to the gray-level weights. That is, a gray-level is changed in proportion to the gray-level weights allocated by the number of sustain discharges. If the sustain pulse of the high level electric potential Vs2 is applied to the Y electrode 312, the sustain discharge is performed by the positive wall charge accumulated around the Y electrode 312 of the discharge cells, the negative wall charge accumulated around the A electrode 322, the electric potential Vs2 applied to the Y electrode 312, and the electric potential Vg applied to the A electrode 322. After the sustain discharge is performed, the positive wall charge and the negative wall charge are accumulated around the X electrode 313 and the Y electrode 312, respectively. If the sustain pulse of the high level Vs2 is applied to the X electrode 313, the sustain discharge is performed by the negative wall charge accumulated around the Y electrode 312 of the discharge cells, the positive wall charge accumulated around the X electrode 313, the electric potential Vg applied to the Y electrode 312, and the electric potential Vs2 applied to the X electrode 313. After the sustain discharge is performed, the negative wall charge and the positive wall charge are accumulated around the X electrode 313 and the Y electrode 312, respectively. Therefore, the sustain discharge is continuously performed according to the number of sustain pulses determined by the gray-level weights.

As described above, a PDP having a new structure according to the present invention improves light-emitting efficiency and reduces permanent afterimage.

In accordance with the method of driving the PDP having the new structure according to the present invention, address discharge is stably and efficiently performed, resulting in the stable performance of a sustain discharge.

Also, the high level electric potential of a display data signal having a high switching frequency can be reduced, thereby reducing switching loss.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. A method of driving a plasma display panel (PDP), comprising the steps of:
providing the PDP with first and second substrates spaced apart from each other, a barrier rib which, together with the first and second substrates, partitions discharge cells which are discharge spaces, first and second electrodes extending so as to cross each other in the barrier rib, a phosphor layer formed in the discharge cells, and a discharge gas in the discharge cells;
dividing each unit frame, used to express an image, into a plurality of sub-fields, each of the sub-fields being divided into a reset period wherein all discharge cells are initialized, an address period wherein a discharge cell which is turned on or off is selected from all discharge cells, and a sustain period wherein a sustain discharge is performed for a discharge cell selected to be turned on in the address period according to gray-level weights allocated to each of the sub-fields;
applying a falling pulse to the first electrode in the reset period; and
applying scan pulses sequentially to the first electrode in the address period;
wherein an electric potential of a low level of the scan pulse is lower than an electric potential of a minimum level of the falling pulse.

2. The method of claim 1, further comprising the step of applying a sustain pulse having alternatively a high level and a low level to the first electrode in the sustain period.

3. The method of claim 2, wherein a bias voltage is applied to the second electrode in the reset period while the falling pulse is applied to the first electrode, a display data signal is applied to the second electrode in the address period in accordance with the scan pulse, and an intermediate electric potential between the high level and the low level of the sustain pulse is applied to the second electrode in the sustain period.

4. The method of claim 1, further comprising the step of applying a rising pulse to the first electrode in the reset period before the falling pulse is applied to the first electrode.

5. The method of claim 4, wherein the rising pulse and the falling pulse are ramp pulses.

6. A method of driving a PDP, comprising the steps of:
providing the PDP with first and second substrates spaced apart from each other, a barrier rib which, together with the first and second substrates, partitions discharge cells which are discharge spaces, first and second electrodes extending in a direction in the barrier rib, a third electrode extending so as to cross the first and second electrodes in the barrier rib, a phosphor layer formed in the discharge cells, and a discharge gas in the discharge cells;
dividing each unit frame, used to express an image, into a plurality of sub-fields, each of the sub-fields being divided into a reset period wherein all discharge cells are initialized, an address period wherein a discharge cell which is turned on or off is selected from all discharge cells, and a sustain period wherein a sustain discharge is performed for a discharge cell selected to be turned on in the address period according to gray-level weights allocated to each of the sub-fields;
applying a falling pulse to the first electrode in the reset period; and
applying scan pulses sequentially to the first electrode in the address period;
wherein an electric potential of a low level of the scan pulse is lower than an electric potential of a minimum level of the falling pulse.

7. The method of claim 6, further comprising the step of applying sustain pulses, having alternately a high level and a low level, to the first electrode and the second electrode in the sustain period.

8. The method of claim 7, further comprising the steps of applying a bias voltage to the second electrode between the reset period where the falling pulse is applied and the address period, and applying a display data signal to the third electrode in the address period in accordance with the scan pulse.

9. The method of claim 6, further comprising the step of applying a rising pulse to the first electrode in the reset period before the falling pulse is applied to the first electrode.

10. The method of claim 9, wherein the rising pulse and the falling pulse are ramp pulses.

11. A plasma display apparatus, comprising:
a PDP which includes first and second substrates spaced apart from each other, a barrier rib which, together with the first and second substrates, partitions discharge cells which are discharge spaces, first and second electrodes extending so as to cross each other in the barrier rib, a phosphor layer formed in the discharge cells, and a discharge gas in the discharge cells; and
drivers for applying a driving signal which is divided into reset, address and sustain periods to each of the first and second electrodes so as to drive the PDP, wherein each unit frame used to express an image is divided into a plurality of sub-fields, and each of the sub-fields is divided into the reset period wherein all discharge cells are initialized, the address period wherein a discharge cell which is turned on or off is selected from all discharge cells, and the sustain period wherein a sustain discharge is performed for a discharge cell selected to be turned on in the address period according to gray-level weights allocated to each of the sub-fields,
wherein the drivers are classified into a first driver which applies the driving signal to the first electrode, and a second driver which applies the driving signal to the second electrode; and
wherein the first driver applies a falling pulse in the reset period and a scan pulse in the address period to the first electrode, an electric potential of a low level of the scan pulse being lower than an electric potential of a minimum level of the falling pulse.

12. The plasma display apparatus of claim 11, wherein the first driver applies a sustain pulse having alternatively a high level and a low level to the first electrode in the sustain period.

13. The plasma display apparatus of claim 12, wherein the second driver applies a bias voltage to the second electrode in the reset period while the first driver applies the falling pulse to the first electrode, applies a display data signal to the second electrode in the address period in accordance with the scan pulse, and applies an intermediate electric potential between the high level and the low level of the sustain pulse to the second electrode in the sustain period.

14. The plasma display apparatus of claim 1 1, wherein the first driver applies a rising pulse to the first electrode in the reset period before the first driver applies the falling pulse the first electrode.

15. The plasma display apparatus of claim 14, wherein the rising pulse and the falling pulse are ramp pulses.

16. A plasma display apparatus, comprising:
a PDP which includes first and second substrates spaced apart from each other, a barrier rib which, together with the first and second substrates, partitions discharge cells which are discharge spaces, first and second electrodes extending in a direction in the barrier rib, a third electrode extending so as to cross the first and second electrodes in the barrier rib, a phosphor layer formed in the discharge cells, and a discharge gas in the discharge cells; and
drivers for applying a diving signal which is divided into reset, address, and sustain periods to each of the first, second and third electrodes so as to drive the PDP, wherein each unit frame used to express an image is divided into a plurality of sub-fields, and each of the sub-fields is divided into the reset period wherein all discharge cells are initialized, the address period wherein a discharge cell which is turned on or off is selected from all discharge cells, and the sustain period wherein a sustain discharge is performed for a discharge cell selected to be turned on in the address period according to gray-level weights allocated to each of the sub-fields;
wherein the drivers are divided into a first driver which applies the driving signal to the first electrode, a second driver which applies the driving signal to the second electrode, and a third driver which applies the driving signal to the third electrode; and
wherein the first driver applies a falling pulse in the reset period and a scan pulse in the address period to the first electrode, an electric potential of a low level of the scan pulse being lower than an electric potential of a minimum level of the falling pulse.

17. The plasma display apparatus of claim 16, wherein the first and second drivers apply a sustain pulse having alternatively a high level and a low level to the first and second electrodes in the sustain period.

18. The plasma display apparatus of claim 17, wherein the second driver applies a bias voltage to the second electrode in the reset period while the first driver applies the falling pulse to the first electrode, and the third driver applies a display data signal to the third electrode in the address period in accordance with the scan pulse.

19. The plasma display apparatus of claim 16, wherein the first driver applies a rising pulse to the first electrode in the reset period before the first driver applies the falling pulse the first electrode.

20. The plasma display apparatus of claim 19, wherein the rising pulse and the falling pulse are ramp pulses.
